(19) United States
(12) Patent Application Publication
(10) Pub. No.: US 2008/0004843 A1
(43) Pub. Date: Jan. 3, 2008

(54) System and method for performing a Zonal Safety Analysis in aircraft design

(75) Inventor: Emilio Jesus Pozuelo Cabrera, Madrid (ES)

Correspondence Address: LADAS & PARRY, 26 WEST 61ST STREET, NEW YORK, NY, 10023, US

(73) Assignee: AIRBUS ESPANA, S.L.

(21) Appl. No.: 11/516,029

(22) Filed: Sep. 5, 2006

(30) Foreign Application Priority Data
Jun. 30, 2006 (ES) 200601774

(51) Int. Cl. G06F 17/50

(52) U.S. Cl. 703/1

(57) ABSTRACT

System and method for performing and managing the Zonal Safety Analysis of the design of an aircraft in which: a) it is obtained a checklist of requirements (15) for said aircraft part, partitioned in predetermined zones; b) it is obtained all design information for each zone of said at least one aircraft part, including a digital mock-up (35); c) it is inspected the compliance with said requirements by the design of each of said zones, performing the inspection in said digital mock-up (35) for at least one requirement; d) the non-compliance cases and the corresponding design changes (55) are managed.

### FIELD OF THE INVENTION

The present invention refers to the Zonal Safety Analysis performed in aircraft design and in particular to a system and method for its optimization.

### BACKGROUND OF THE INVENTION

The Zonal Safety Analysis (ZSA) is an activity which represents one of the common practices of the worldwide aeronautical industry and it is required by current International Safety Regulations (EASA, FAA, etc).

The ZSA addresses all the hazards associated with the systems installation in the aircraft, by identifying the implications of the physical installation of systems hardware considered as a whole on the global aircraft safety assessment:
Determination of Compliance with the Installation Rules.
Identification of Potential Cascade Failures due to System Interaction.
Identification of Potential Areas for System Maintenance Errors.
Identification of Potential Areas for System Malfunction due to Environmental Factors.

The ZSA is a part of the Common Cause Analyses and it is performed concurrently with Particular Risk Analysis and Common Mode Analysis during the aircraft design phases.

The ZSA is a qualitative safety assessment and it is very dependent on good engineering judgment and a deep knowledge of in-service experience of similar aircraft types.

The ZSA is a very complex analysis in which there are numerous interrelationships between different involved disciplines, as well as systems and aircraft parts.

In addition, ZSA requires links to other designing tools used in the aircraft design process, as CAD/CAM tools for example.

Today, no particular tool aimed to deal with ZSA exists in the aeronautical industry. Some existing tools, like IRIS (Interactive Routing and Installation of Systems) or CASIMIR (TBD) used in AIRBUS, are only focused on Engine Burst or Tyre Burst Particular Risk Analyses or just on the assurance of basic distance segregation rules to avoid collision of systems routing.

Other attempts to create a ZSA platform, like the ISAAC project (Improvement of Safety Activities on Aeronautical Complex systems), do not develop any particular tool for performing the analysis itself, rather, a link between the existing tools in the “geometrical world” (CATIA, IRIS, etc) and the “functional world” given by ESACS (Enhanced Safety Platform for Complex Systems) platform which provides a representation of functional interdependencies between systems and aircraft items.

Therefore, dedicated systems fully integrated with geometrical tools for performing this ZSA, especially in the very early design phases, as well as a management systems to monitor such design from the very early design phases up to the latest stages of the development phases, and to force all the involved parties into the workflow, are needed in the aeronautical industry to optimize the aircraft design and to enhance the safety of the product.

Therefore, the present invention is focused on this demand.

### SUMMARY OF THE INVENTION

In one aspect, the present invention provides a computer-aided method for performing and managing the ZSA of the design of at least an aircraft part comprising the following steps:

Obtaining a checklist of requirements for said aircraft part, partitioned in predetermined zones.

Obtaining all design information for each zone of said at least one aircraft part, including a digital mock-up.

Inspecting the compliance with said requirements by the design of each of said zones, performing the inspection in said digital mock-up for at least one requirement.

Managing the non-compliance cases and the corresponding design change.

In another aspect, the present invention provides a computer system for performing and managing the ZSA of the design of at least an aircraft part comprising:

Storage means for storing: the design and installation rules to be followed in the aircraft design; all the design information for said at least one aircraft part, partitioned in predetermined zones, including a digital mock-up; and a failure mode library for each aircraft component installed in said zones.

Processing means for: preparing a checklist of requirements for each of said zones; inspecting the compliance with said requirements by the design of each of said zones, performing the inspection in said digital mock-up for at least one requirement; and managing the non-compliance cases and the corresponding design change.

Some advantages of the present invention are the following:

Earliest and highest involvement of specialists.

Collaborative work due to integration of team.

Improved communication between the actors, even if they are in different sites (the tool would incorporate conferencing sessions capability).

Capability of studying and managing a large number of alternatives and iterations.

Reduction in design errors.

Time reduction.

Money saving.

Other features and advantages of the present invention will be understood from the following detailed description thereof in relation to the attached figures.

### DESCRIPTION OF THE DRAWINGS

FIG. 1 shows a diagram illustrating the obtainment of the ZSA checklist of requirements.

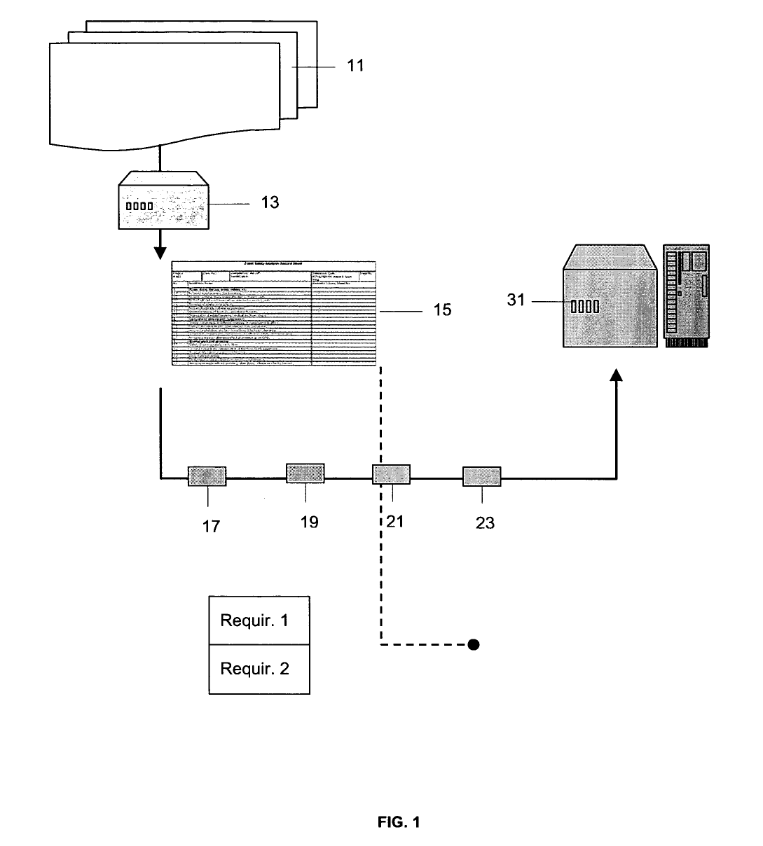

FIG. 2 shows a diagram illustrating the obtainment and validation of the aircraft design information to be used in the ZSA.

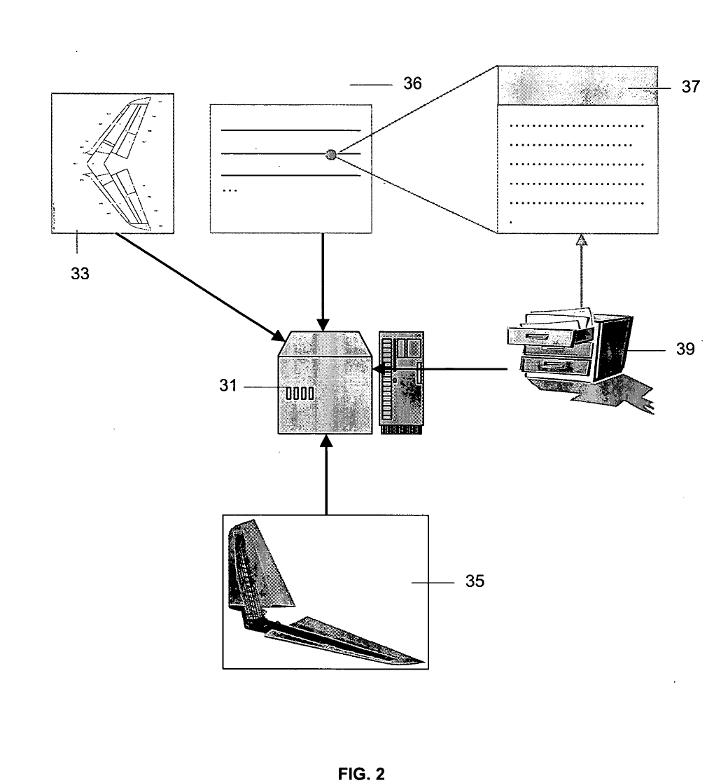

FIG. 3 shows a diagram illustrating the inspection of the requirements which is performed in the ZSA.

FIG. 4 shows a diagram illustrating the management of the cases in which the aircraft design does not comply with a requirement.

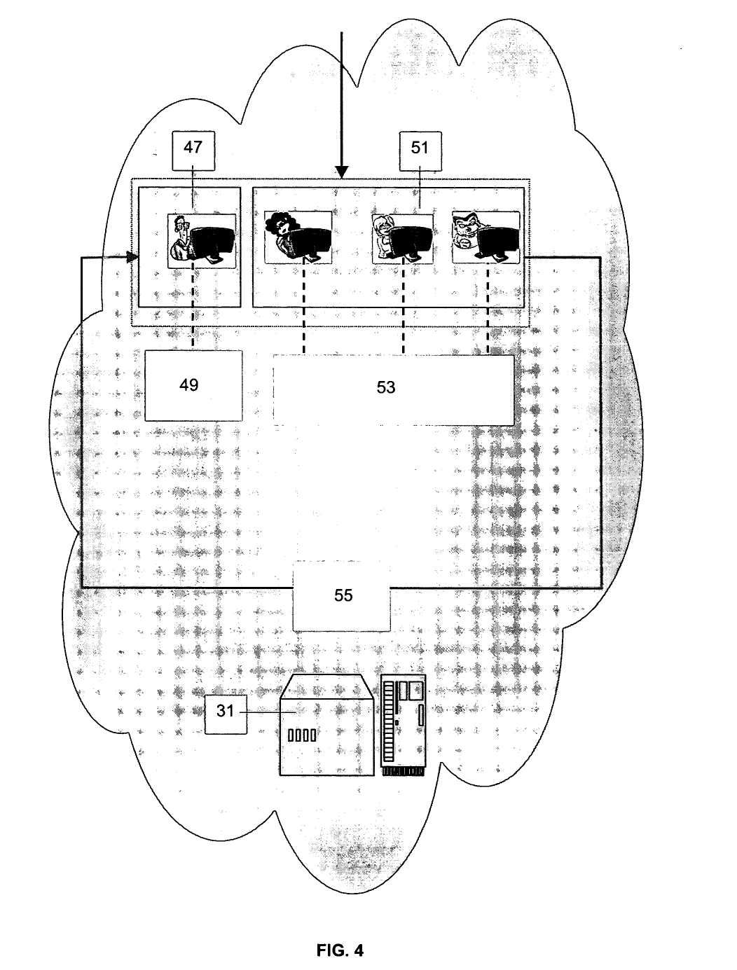

FIG. 5 shows an HTP zoning.

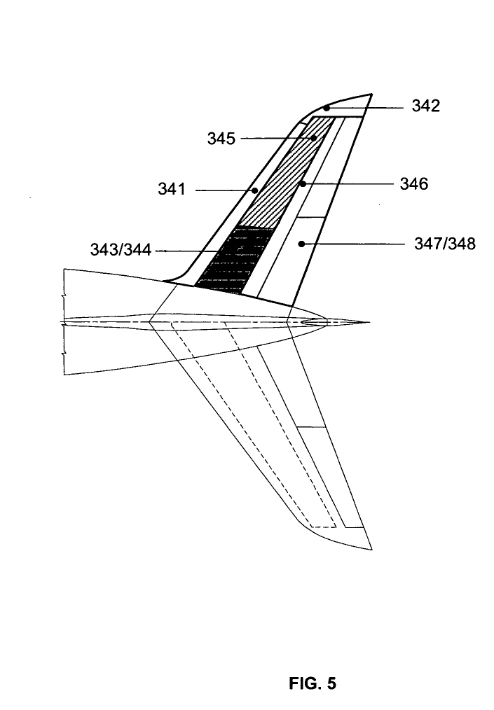

### DETAILED DESCRIPTION OF THE INVENTION

The first step of the method according to this invention: a) Obtaining a checklist of requirements, comprises the following sub-steps:

a1) Storing of Design and Installation Rules.

In this step, Design and Installation rules 11 such as Technical Design Directives (TDDs), Requirements from FHA/PSSA, Requirements from System/Equipment Installation Requirements Documents (SIRD/EIRD) and Experience Design Requirements (EDRs) are stored in a computer system.

a2) Preparation of the checklist of requirements.

A checklist 15 with all requirement applicable to the aircraft is prepared processing Design and Installation rules 11 with suitable computer-aided Management tools 13.

Examples of said requirement are the following.

Requirement 1: “The maximum length of pipe to be used between supports is as follows for pipes with flexible couplings:

| Pipe diameter d | Pipe wall thickness t | Maximum length l |
|---|---|---|
| (inches) | (mm) | (mm) |
| 0.75 | 0.7 | 1100 |
| 1.0 | 0.7 | 1240 |
| 1.5 | 0.7 | 1400 |
| 2.0 | 0.7 | 1520 |
| 2.5 | 0.7 | 1600 |
| 3.0 | 0.9 | 1800 |
| 3.5 | 0.9 | 1880 |
| 4.0 | 1.2 | 2080″ |

Requirement 2: “All pipes, ducts, hoses, wires, cables, etc. that are attached to moving parts should be mounted in such a way as to minimize stress.”

The preparation of said checklist involves the participation of several technicians such as Zonal Safety specialists (ZSA) and Safety/Reliability specialists SSA) 17, System Designers (per ATA) 19, System Installators (electrical, hydraulics, fuel, etc) 21 and Structure Designers 23.

Name and contact details of said technicians are also stored to be used, for instance, to send automatic alerts for requesting actions on the workflow process involved in this step.

The complete checklist 15 is stored in a ZSA server 31. It can be particularized automatically to a particular aircraft zone to be analyzed.

The second step of the method according to this invention: b) Obtaining all design information of the aircraft comprises the following sub-steps:

b1) Obtaining and storing zoning information of the aircraft

The zone partitioning of the aircraft and boundaries 33 (name/number in accordance with the established aircraft zoning) is obtained and stored in ZSA server 31.

For example if the ZSA is carried out for an Horizontal Tail Plane (HTP), the zoning can be the following:

Zone 341: Trimmable Horizontal Stabiliser Leading Edge.

Zone 342: Trimmable Horizontal Stabiliser Tip.

Zone 343/344: Trimmable Horizontal Stabiliser Fuel Tank between ribs 4 and 9.

Zone 345: Trimmable Horizontal Stabiliser Spar box Dry Area from rib 9 to 25.

Zone 346: Trimmable Horizontal Stabiliser Trailing Edge.

Zone 347/348: Inner and Outer Elevator Zone.

In this sub-step, the responsibility for each zone is allocated.

b2) Obtaining and storing in ZSA server 31 a digital mock up 35 of the aircraft part to be analysed.

The digital mock up 35 is a collection of 3D models which are positioned in 3D space to represent the form of the aircraft part to be analysed which are generated using CAD/CAM files containing the aircraft geometry and systems installation

b3) Obtaining and storing in server 31 a list 36 of components in each aircraft zone.

List 36 contains items such as: Fuel pump, Trim tank pump isolation valve, Trim tank inlet valve, etc.

b4) Obtaining and storing in server 31 information 37 regarding each component of the list 36.

Exemplary component information 37 shall include all necessary information for the ZSA such as: operational information in normal functioning, external effects in normal functioning, failure or degraded mode, protection means, etc.

b5) Obtaining and storing in server 31 a failure modes library 39 for each component.

The failure modes will be recorded from historical data, SIRDs, FMEAs, Airworthiness requirements, etc.

The system will be able to modelize the failure based on the failure modes assigned to each component and check if the requirements related to the hazard and the potential affected installation are fulfilled.

The third step of the method according to this invention: c) Inspecting the compliance with requirements by the design of each of said zones comprises the following sub-steps:

c1) Inspection.

The inspection of the zone is performed either on digital mock-up or on the aircraft. External devices 41 and digital videocameras 43 can be used in this step.

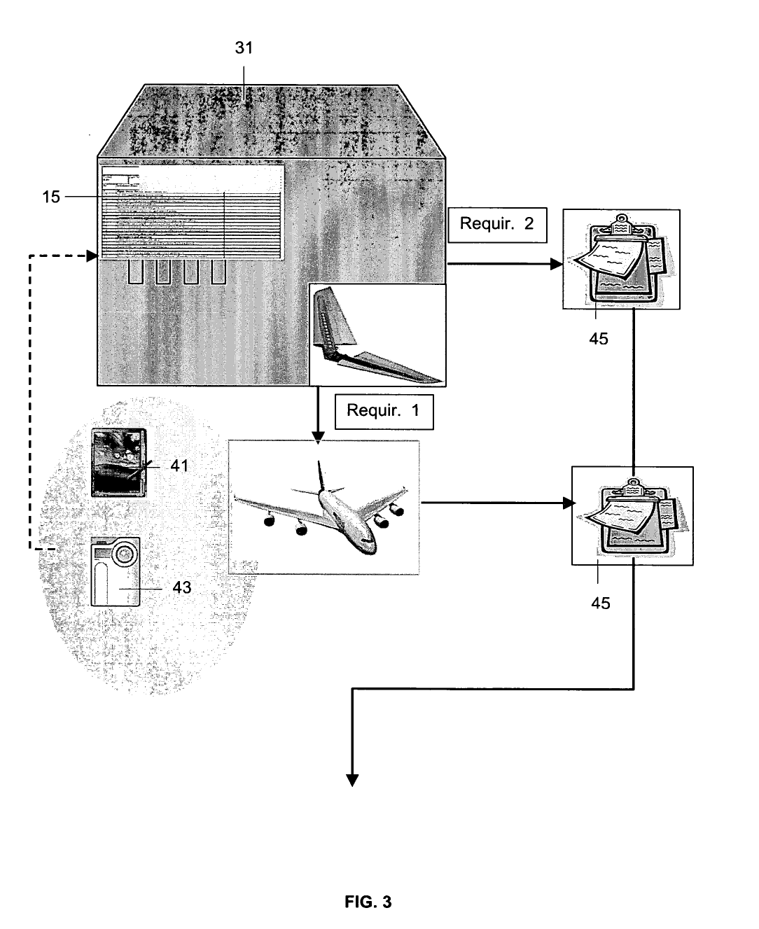

As illustrated in FIG. 3 inspection of Requirement 2 above-mentioned is performed on the aircraft and inspection of Requirement 1 above-mentioned is performed on digital mock-up.

The system will have a high level of automatism in performing the inspection of the aircraft zones into the digital mock-up.

c2) Issuance of Query Sheets.

For the non-compliances identified, Query Sheets 45 are generated to be transmitted to the different specialists.

The fourth step of the method according to this invention d) Managing the non-compliance cases and the corresponding design change involves the following process.

Query Sheets 45 are sent firstly to the safety group 47 to inform them on the deviation to the installation rule, which will propose the design recommendation 49. Second, they are sent to the system installation/structure desing group 51 to take the corrective action 53 and launch the design change 55. The process will be finished after validation of the design change 55 by the safety group 47.

For example, Query Sheet 45 may report the finding that “Horizontal Stabilizer Trailing Edge RH 2SF electrical route could be in contact with the servo actuator rod during its movement” and then the safety group issue a design recommendation 49 “Add two NSA5527-03-15 spacers in clipping points adjacent to the rod. This action will increase the distance to the rod and will avoid the contact.”. Subsequently, the system installation group 51 take the corrective action 53 “Closed trough implementation of change event ABCD for MSN002 and up”

For those issues which examination has not been possible automatically by the system into the digital mock-up, the system will request to check it on the aircraft, giving a list of items to be verified on the aircraft during the review.

The system will allow to open a new “query sheet” after the aircraft inspection with the possibility to store data and picture of the identified problem (aircraft, affected zone, components involved, description of the problem, actors involved, status, etc.).

Data from configuration management tools need to be able to be fed into the system to allow the tool to perform the follow-up on all the aircraft during the manufacturing process.

The system will follow-up automatically the Query sheets” in order to achieve its closure in accordance with the established schedule as identified in the aircraft project milestones.

Finally the system will generate automatically a ZSA technical report declaring conformity with safety requirements.

Any modifications comprised within the scope defined by the following claims may be introduced in the embodiments described above.

1. A computer-aided method for performing and managing the Zonal Safety Analysis of the design of at least an aircraft part comprising the following steps:
a) obtaining a checklist of requirements (15) for said aircraft part, partitioned in predetermined zones;
b) obtaining all design information for each zone of said at least one aircraft part, including a digital mock-up (35);
c) inspecting the compliance with said requirements by the design of each of said zones, performing the inspection in said digital mock-up (35) for at least one requirement;
d) managing the non-compliance cases and the corresponding design change (55).

2. A computer-aided method for performing and managing the Zonal Safety Analysis of the design of at least an aircraft part according to claim 1, wherein the obtainment of said checklist of requirements (15) includes processing Design and Installation Rules (11) with Management tools (13).

3. A computer-aided method for performing and managing the Zonal Safety Analysis of the design of at least an aircraft part according to claim 1, wherein the obtainment of all design information for each zone includes the obtainment of a list (36) of components, component information (37) and a failure modes library (39) for each component.

4. A computer system for performing and managing the Zonal Safety Analysis of the design of at least an aircraft part comprising:
a) storage means for storing:
a1) design and installation rules;
a2) all design information for said at least one aircraft part, including a digital mock-up, partitioned in predetermined zones;
a3) a failure mode library for each aircraft component installed in said zones;
b) processing means for:
b1) preparing a checklist of requirements for each of said zones;
b2) inspecting the compliance with said requirements by the design of each of said zones, performing the inspection in said digital mock-up for at least one requirement;
b3) managing the non-compliance cases and the corresponding design change.
